(19) United States
(12) Patent Application Publication
(10) Pub. No.: US 2009/0064431 A1
(43) Pub. Date: Mar. 12, 2009

(54) Magnetic Wash Strip And Method Of Use

(76) Inventor: Edward Holbus, Racine, WI (US)

Correspondence Address: QUARLES & BRADY LLP, 411 E. WISCONSIN AVENUE, SUITE 2040, MILWAUKEE, WI, 53202-4497, US

(21) Appl. No.: 12/193,438

(22) Filed: Aug. 18, 2008

Related U.S. Application Data
(60) Provisional application No. 60/971,137, filed on Sep. 10, 2007.

(51) Int. Cl. B60S 3/04

(52) U.S. Cl. 15/97.3; 134/32

(57) ABSTRACT

An automatic vehicle washing apparatus wash strip having at least one magnet that adheres the wash strip to the vehicle being washed.

### CROSS REFERENCES TO RELATED APPLICATIONS

This application claims the priority of Provisional Patent Application Ser. No. 60/971,137, filed Sep. 10, 2007, the entire disclosure of which is expressly and fully incorporated herein by reference.

### STATEMENT REGARDING FEDERALLY SPONSORED RESEARCH

Not Applicable.

### FIELD OF INVENTION

This invention relates to automatic vehicle washing, and particularly to a wash strip and method of using the wash strip in an apparatus for automatically washing the exterior of an automobile or other similar vehicles.

### BACKGROUND OF INVENTION

Automatic vehicle washing apparatus is well known. The apparatus typically takes one of two generic forms. In one form, an automobile is moved by a conveyor through successive stations at which various washing operations take place, such as wetting, scrubbing and rinsing. The second approach is to automatically perform these same operations upon a stationary vehicle. The present invention is adaptable to both forms of washing apparatus.

In automatic car washes having wash strips, i.e. strips of material that contact the vehicle being washed, contact between the wash strips and vehicle being washed is necessary to dislodge dirt and grime from the vehicle. Unfortunately, because of different size vehicles, often one or more of the strips either fail to make contact with the vehicle or only briefly contact the vehicle before falling away. As a result the vehicle being washed does not receive a thorough cleaning. Therefore, a need exists for an automatic vehicle washing apparatus wash strip that maintains contact with the vehicle for extended periods during a wash cycle.

### SUMMARY OF THE INVENTION

The present invention provides an automatic vehicle washing apparatus wash strip that magnetically adheres to a vehicle being washed.

A general objective of the present invention is to provide an automatic vehicle washing apparatus wash strip that adheres to a vehicle being washed. This objective is accomplished by providing wash strips having one or more magnets fixed thereto. The magnets adhere the wash strip to the vehicle being washed to provide a thorough cleaning.

The foregoing and other objects and advantages of the invention will appear from the following detailed description. In the description, reference is made to the accompanying drawings which illustrate a preferred embodiment of the invention.

### BRIEF DESCRIPTION OF THE DRAWINGS

FIG. 1 is a perspective view of a vehicle wash apparatus incorporating the present invention;

FIG. 2 is an elevation view of the wash strips of FIG. 1; and

FIG. 3 is a cross sectional view of the wash strip of FIG. 1.

### DETAILED DESCRIPTION OF THE PREFERRED EMBODIMENT

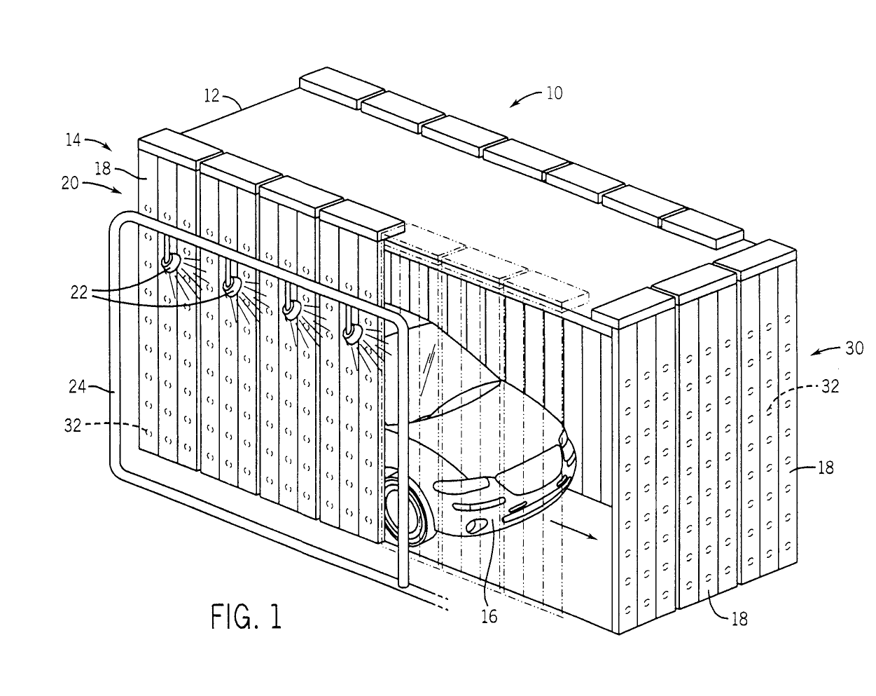

Referring to FIG. 1, the vehicle wash apparatus 10 includes a frame 12 supporting a vehicle wash mechanism 14 which washes a vehicle 16, such as a car, truck, and the like, containing a magnetically attracted metal. In the embodiment disclosed herein, the vehicle 16 moves along the frame 12 and is washed using elongated wash strips 18 and water. The vehicle wash mechanism 14 horizontally reciprocates the water soaked absorbent wash strips 18 using methods known in the art, such as a motor driving a cam shaft and the like. Water sprayed toward the vehicle 16 being washed from nozzles 22 in fluid communication with water supply lines 24 urges the wash strips 18 against the vehicle 16. The water in cooperation with the reciprocating action of the wash strips 18, dislodges and rinses away dirt and grime on the vehicle 16.

As shown in FIG. 1, a first set 20 of the wash strips 18 is interposed between the nozzles 22 spraying water toward the vehicle 16 and the vehicle 16 to urge the wash strips 18 against the vehicle 16. Advantageously, magnets 32 fixed to the wash strips 18 adhere the wash strips 18 to the vehicle 16. As a result, once attached to the vehicle 16, the individual wash strips 18 do not fall away from the vehicle 16 until the vehicle 16 has passed the reach of the individual wash strips 18.

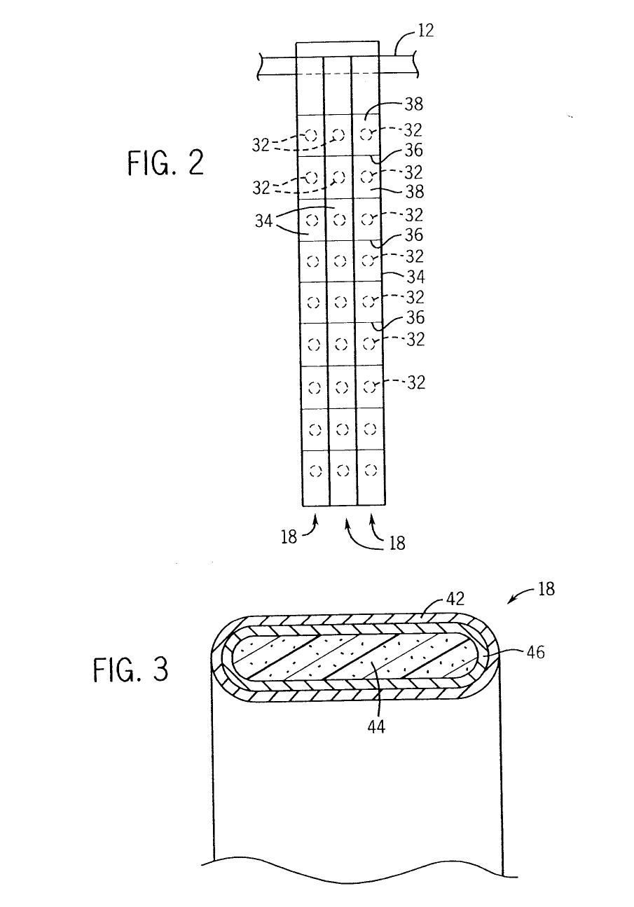

As shown in FIG. 2, each wash strip 18 is an elongated strip of material 34, such as described below, hung from the frame 12 and includes a plurality of the magnets 32 fixed to the strip of material 34. Preferably, each wash strip 18 includes a plurality of individual magnets 32 spaced along the length of the wash strip 18. Although a plurality of spaced magnets 32 is preferred, a magnetic strip extending a portion of the length of the wash strip 18, can be used without departing from the scope of the invention. Moreover, although nine magnets 32 in each wash strip 18 is shown, one or more magnets can be used without departing from the scope of the inventions.

The magnets 32 are fixed to the wash strip 18 using any methods known in the art. In one embodiment, each magnet 32 is sewn to the wash strip 18 using thread. Alternatively, pockets can be formed in the wash strip 18 that receive and hold the magnets 32. Preferably, as shown in FIG. 2, seams 36 sewn through the wash strip 18 are spaced along the length of the wash strip 18 and form hollow sections 38 in the wash strip 18. A magnet 32 disposed in each section 38 is prevented from passing into adjacent sections 38 by the seams 36 to maintain spacing between the magnets 32. Preferably, each magnet is encapsulated or coated with a material, such as plastic, to prevent the magnet from rusting.

As shown in FIG. 3, each wash strip 18 preferably includes an external cover 42 formed from elongated lengths of a microfiber fabric. The multi-filament fibers of the microfiber fabric have a diameter of less than 1.0 denier per filament to provide a nonabrasive fabric which does not damage a vehicle finish. Preferably, the wash strips 18 used in the present invention include fabric containing between approximately 70% and 80% polyester and between approximately 20% and 30% polyamide which resists stretching and is nonabrasive, such as available from Edge Tech Industries, San Diego, Calif. Most preferably, the fabric is woven using a waffle weave which inhibits the strip from stretching and coiling during using.

Sponges 44 are enclosed in the cover 42 to provide self cleaning wash strips 18. The sponges 44 are fixed to the cover 42 using methods known in the art, such as sewing, and the like. Water penetrates both the microfiber fabric cover 42 and the sponges 44 to saturate the sponges 44 with the water. When the sponges 44 enclosed in the microfiber fabric cover 42 become saturated, as the sponges are compressed during the washing operation, water flows outwardly from the saturated sponges 44 enclosed within the wash strip 18. The outwardly flowing water forces out the dirt that collects on the microfiber fabric cover 42. This outflow of water from the sponges 44 reverse cleans the wash strip 18 to prevent buildup of dirt on the microfiber fabric cover 42.

A filter material 46, such as a nylon filter cloth, interposed between the sponge 44 and external cover 42 filters the water absorbed by the sponge 44 to prevent the sponge 44 from fouling. Although a wash strip material 34 including an external microfiber external cover 42, filter material 46, and sponge 44 is preferred, the wash strip material 34 can be a single strip of material, such as fabric, foam, and the like without departing from the scope of the invention.

The wash strips 18 shown in FIG. 1 engage one side of the vehicle 16. A second set of wash strips 18, provided on the other side of the vehicle 16 adheres to the other side of the vehicle 16. As shown in FIG. 1, a third set 30 of wash strips 18 is also hung from the frame 12 in the path of the vehicle 16. This third set of wash strips 18 drapes over the front, back, and top of the vehicle 16 as the vehicle 16 passes beneath the third set of wash strips 18. Preferably, the wash strips 18 comprising this third set of wash strips 18 are substantially identical to the wash strips 18 adhering to the vehicle sides. However, the third set of wash strips 18 can comprise non-magnetic wash strips without departing from the scope of the invention.

In use, the vehicle 16 moves along a vehicle path adjacent the first and second set of wash strips 18 and below the third set of wash strips 18. The nozzles 22 direct water toward the vehicle 16 to urge the wash strips 18 interposed between the nozzles 22 and vehicle 16 against the vehicle 16. The third set of wash strips 18 engage the vehicle 16 as the vehicle 16 passes beneath the third set of wash strips 18. Subsequent wash stations can be provided to wax and dry the vehicle 16, if desired. Preferably, water from a high pressure pump is directed at the vehicle 16 to remove any large deposits of mud or snow prior to engaging the vehicle 16 with the wash strips 18.

While there has been shown and described what are at present considered the preferred embodiments of the invention, it will be obvious to those skilled in the art that various changes and modifications can be made therein without departing from the scope of the invention defined by the appended claims.

I claim:

1. A vehicle washing apparatus wash strip for use in a vehicle washing apparatus washing vehicles, said wash strip comprising:
an elongated strip of material extending from a vehicle washing apparatus washing a vehicle; and
at least one magnet fixed to said wash strip adhering said wash strip to the vehicle being washed.

2. The wash strip as in claim 1, in which a plurality of magnets are spaced along a length of said wash strip.

3. The wash strip as in claim 1, in which said wash strip includes a sponge enclosed by an external cover.

4. The wash strip as in claim 3, including a filter material interposed between said external cover and sponge.

5. A method of using an automatic vehicle washing apparatus wash strip in an automatic vehicle washing apparatus washing a vehicle, said method comprising:
magnetically adhering the wash strip to the vehicle being washed.

6. The method as in claim 5, in which said wash strip is urged against the vehicle by a liquid sprayed toward the vehicle being washed.

7. The method as in claim 5, in which said wash strip comprises an elongated strip of material extending from the vehicle washing apparatus, and at least one magnet fixed to said wash strip adhering said wash strip to the vehicle being washed.

8. The method as in claim 7, in which a plurality of magnets are spaced along a length of said wash strip.

9. The method as in claim 5, in which said wash strip includes a sponge enclosed by an external cover.

10. The method as in claim 9, including a filter material interposed between said external cover and sponge.
